(19) United States
(12) Patent Application Publication
(10) Pub. No.: US 2023/0063809 A1
(43) Pub. Date: Mar. 2, 2023

(54) METHOD FOR IMPROVING ROAD TOPOLOGY THROUGH SEQUENCE ESTIMATION AND ANCHOR POINT DETETECTION

(71) Applicant: GM Global Technology Operations LLC, Detroit, MI (US)

(72) Inventors: Yijun Wei, Houston, TX (US); Yehenew G. Mengistu, Novi, MI (US); Orhan Bulan, Novi, MI (US); Sheetal Mahesh, Austin, TX (US)

(21) Appl. No.: 17/411,320

(22) Filed: Aug. 25, 2021

(51) Int. Cl. G01C 21/00

(52) U.S. Cl. CPC G01C 21/3819; G01C 21/3852; G01C 21/3896

(57) ABSTRACT

A system and a method of generating a map for navigating a vehicle. The system includes a remote processor. The remote processor is configured to determine an anchor point for a location of a road segment based on data from at least one data source, place the anchor point within an aerial image of the road segment, predict a boundary marking of the road segment on the aerial image based on the anchor point, and provide the boundary marking to the vehicle. A vehicle processor navigates the vehicle along the road segment using the boundary marking.

### INTRODUCTION

The subject disclosure relates to navigation of autonomous vehicles and, in particular, to a system and method for determining a lane boundary within a road segment for vehicle navigation based on data from one or more data sources.

Autonomous vehicles often navigate using data from map services which identify the location of the center of the road, lane markings, etc. Ideally, data from these map services are points that indicate at least the location of the center of the road. In practice, however, these points can deviate significantly from the actual center of the road, leading to poor map construction and poor vehicle navigation. Accordingly, it is desirable to specify the location of the center marking and other road boundaries with greater accuracy to improve the road topology in existing navigation maps.

### SUMMARY

In one exemplary embodiment, a method of generating a map is disclosed. An anchor point is determined for a location of a road segment based on data from at least one data source. The anchor point is placed within an aerial image of the road segment. A boundary marking of the road segment is predicted on the aerial image based on the anchor point to form the map. The map is provided to a vehicle.

In addition to one or more of the features described herein, the at least one data source includes at least one of a vehicle telemetry data source, crowd-sourced data, and an aerial imagery data source. Determining the anchor point further includes determining a plurality of candidates, each candidate having an associated confidence level, and selecting a candidate as the anchor point from the plurality of candidates based on the associated confidence level. The boundary marking of the road segment further includes at least one of a center marking of the road segment, a lane marking of the road segment, and an edge marking of the road segment. In an embodiment, the boundary marking is missing on a previously generated map from a map service. The method includes comparing the predicted boundary marking to a boundary marking in the previously generated map from service to identify an error in the map from the map service. The method further includes determining the anchor point and the predicted boundary marking of the road segment at a remote processor and providing the predicted boundary marking to a processor of the vehicle to operate the vehicle. The method further includes navigating the vehicle along the road segment using the boundary marking in the map.

In another exemplary embodiment, a system for generating a map is disclosed. The system includes a processor configured to determine an anchor point for a location of a road segment based on data from at least one data source, place the anchor point within an aerial image of the road segment, predict a boundary marking of the road segment on the aerial image based on the anchor point, and provide the boundary marking to a vehicle for navigation of the vehicle along the road segment.

In addition to one or more of the features described herein, the at least one data source includes at least one of a vehicle telemetry data source, crowd-sourced data, and an aerial imagery data source. Determining the anchor point further includes determining a plurality of candidates, each candidate having an associated confidence level, and selecting a candidate as the anchor point from the plurality of candidates based on the associated confidence level. The boundary marking of the road segment further includes at least one of a center marking of the road segment, a lane marking of the road segment, and an edge marking of the road segment. In an embodiment, the processor is further configured to predict the boundary marking that is missing from a previously generated map from a map service. The processor is further configured to compare the predicted boundary marking to a boundary marking in the previously generated map to identify an error in the map from the map service. In an embodiment, the processor is a remote processor to a vehicle and the processor provides the predicted boundary marking to a vehicle processor that uses the predicted boundary marking to operate the vehicle.

In yet another exemplary embodiment, a system for navigating a vehicle is disclosed. The system includes a remote processor and a vehicle processor. The remote processor is configured to determine an anchor point for a location of a road segment based on data from at least one data source, place the anchor point within an aerial image of the road segment, predict a boundary marking of the road segment on the aerial image based on the anchor point, and provide the boundary marking to the vehicle. The vehicle processor navigates the vehicle along the road segment using the boundary marking.

In addition to one or more of the features described herein, the at least one data source includes at least one of a vehicle telemetry data source, crowd-sourced data, and an aerial imagery data source. Determining the anchor point further includes determining a plurality of candidates, each candidate having an associated confidence level, and selecting a candidate as the anchor point from the plurality of candidates based on the associated confidence level. The boundary marking of the road segment further includes at least one of a center marking of the road segment, a lane marking of the road segment, and an edge marking of the road segment. The remote processor is further configured to predict the boundary marking that is missing from a previously generated map using the anchor point.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a system for vehicle navigation using a road boundary identified in a map;

FIG. 2 shows a road segment having markings that illustrate a mapping method disclosed herein;

FIG. 3 shows a flowchart of a method for estimating a boundary marking;

FIG. 4 shows a flow chart of a method for determining anchor points from the various data sources disclosed herein;

FIG. 5 shows a flowchart of a method of determining anchor points from telemetry data;

FIG. 6 shows a region of a road segment illustrating a method for selecting a separator line using a confidence threshold;

FIG. 7 illustrates a separator line that is not acceptable using the confidence threshold method discussed with respect to FIG. 6;

FIG. 8 shows a flowchart of a method for determining a boundary marking from an aerial image;

FIG. 9 illustrates a stitching step for predicting a boundary marking;

FIG. 10 shows an aerial image of a road segment showing various boundary marking that can be determined using the methods disclosed herein; and

FIG. 11 shows an image illustrating a method for correcting an HD/MD (high definition/low definition) maps for road boundaries.

### DETAILED DESCRIPTION

The following description is merely exemplary in nature and is not intended to limit the present disclosure, its application or uses. It should be understood that throughout the drawings, corresponding reference numerals indicate like or corresponding parts and features.

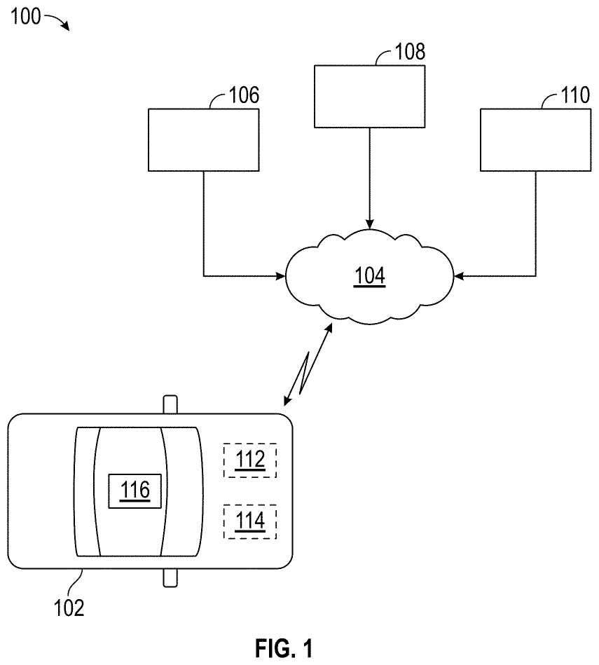

In accordance with an exemplary embodiment, FIG. 1 shows a system 100 for vehicle navigation using a road boundary identified in a map. The system 100 includes a vehicle 102, which can be an autonomous or simi-autonomous vehicle in communication with a map processor or map server 104. The map server 104 can provide the vehicle 102 with high-definition or medium-definition (HD/MD) maps for navigation. The system 100 also includes a plurality of data sources that provide data to the map server 104 to enable the map server 104 to generate maps using the methods disclosed herein. The plurality of data sources can include, but are not limited to, a telemetry data source 106 such as a High-Speed Vehicle Telemetry (HSVT) data source, a crowd-sourced data source 108 that provides crowd-sourced data, and an aerial imagery data source 110, such as the United States Geological Survey (USGS) database, for example.

In an embodiment, the vehicle 102 includes a global positioning system (GPS) 112 and sensors 114 (e.g., lidar system, radar system, one or more cameras, etc.). The vehicle 102 also includes a vehicle processor 116. The vehicle processor 116 can obtain information from the GPS 112, the sensors 114 and the map server 104 and use the information to augment or automate operation of the vehicle 102. The processor 120 and the map server 104 can use processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The map server 104 can perform cloud-based communication, as shown, or can perform cellular or other wireless communication with multiple vehicles (not shown) over a period of time. The map server 104 can receive telemetry data form the vehicle 102 and other vehicles (not shown). Telemetry data includes position information for the vehicle 102 based on the GPS 112, information indicating a direction and speed of the vehicle 102, as well as additional information such as elevation of the vehicle 102, for example. The map server 104 can store the telemetry data received from each vehicle for processing.

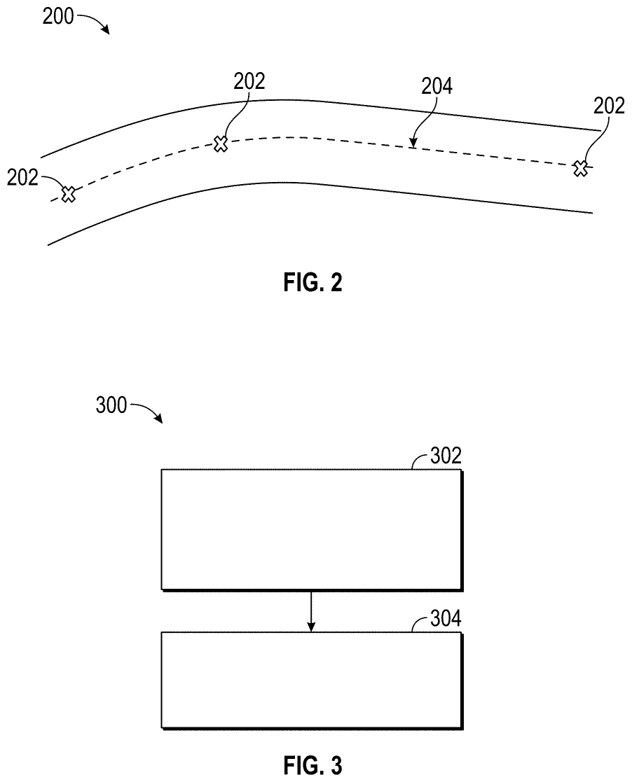

FIG. 2 shows a road segment 200 having markings that illustrate a mapping method disclosed herein. The mapping method draws a boundary marking on the road segment that can be used by vehicles for navigation and to maintain its location within a lane. The boundary marking can be a center marking 204, as shown in FIG. 2, or can be a road edge marking or a lane marking. Anchor points 202 are determined and used to mark one or more locations on the center marking 204 of the road segment 200. The anchor points 202 can be determined by applying the methods disclosed herein to data from one or more data sources, such as the one or more data sources of FIG. 1. The center marking 204 is calculated and placed within the road segment based on the locations of the anchor points 202.

FIG. 3 shows a flowchart 300 of a method for estimating a boundary marking. In box 302, a plurality of anchor points 202 is determined for a plurality of locations along a road boundary of the road segment 200. In box 304, predicted boundary points are generated that connect the plurality of anchor points. The predicted boundary points are generated using the representative anchor points 202 along the road segment 200 and aerial imagery of the road segment. The predicted boundary points form an outline or contour of the boundary marking. A boundary marking can be predicted from the anchor points 202 by inputting the anchor points and an aerial image of the road segment 200 to a machine learning program or neural network, such as a Long Short Term Memory (LSTM) neural network.

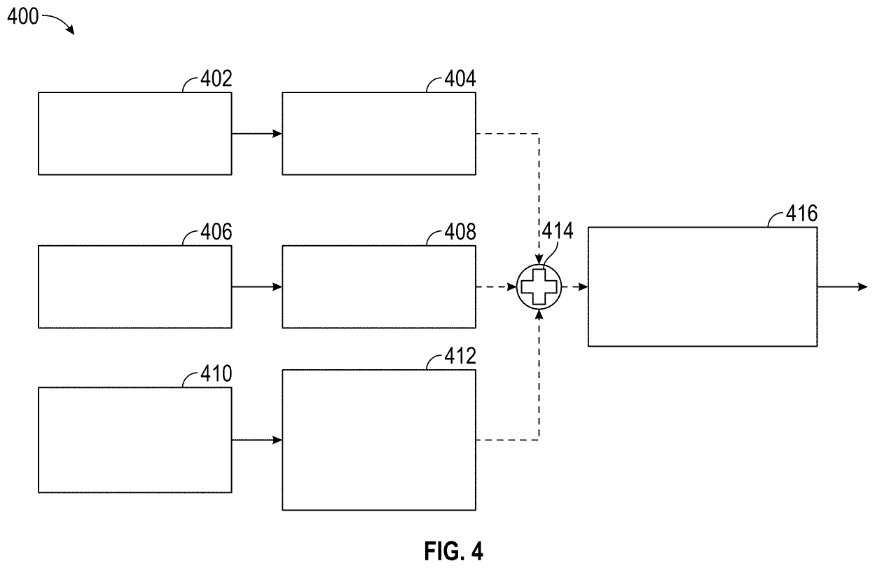

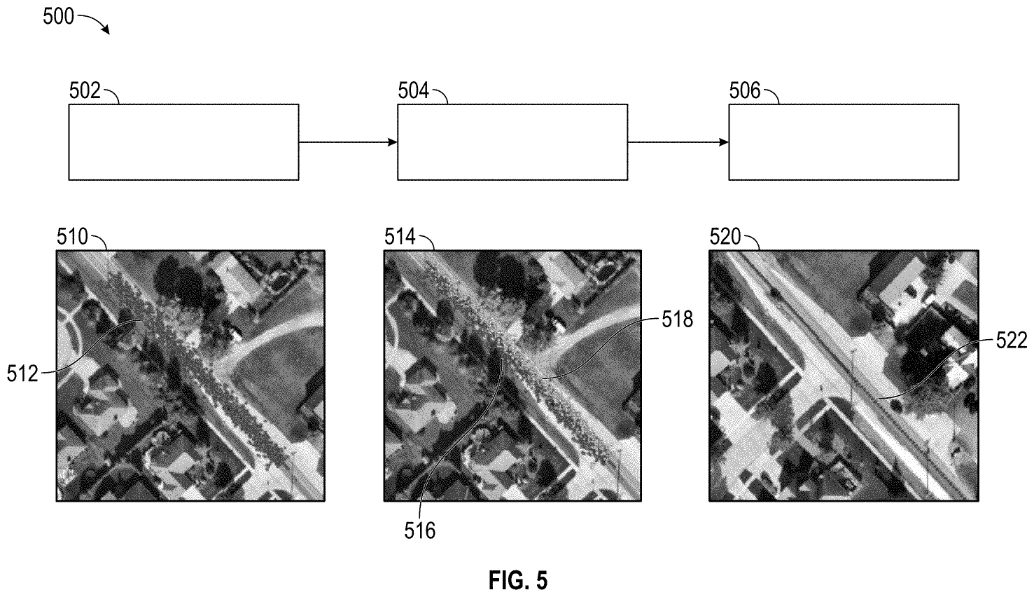

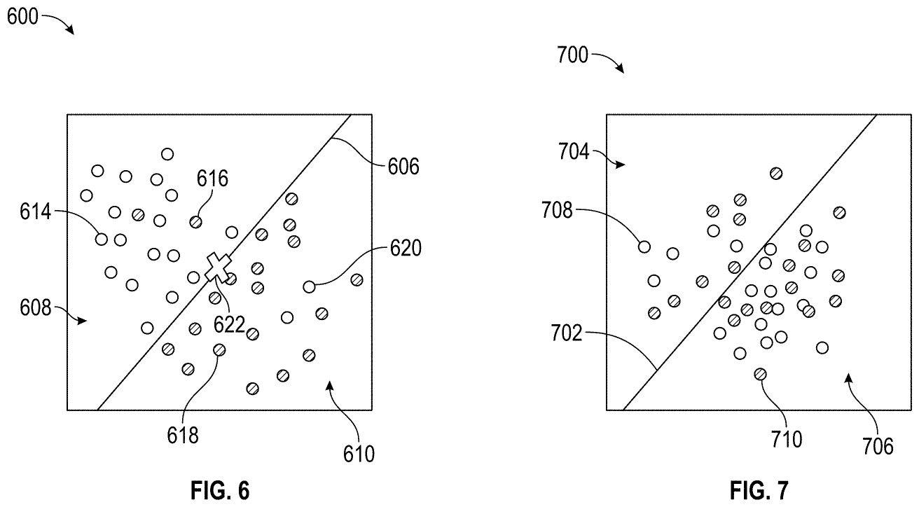

FIG. 4 shows a flowchart 400 of a method for determining anchor points 202 from the various data sources disclosed herein. In box 402, telemetry data is received and aggregated at the map server 104. The telemetry data includes data from a plurality of vehicles, which can include vehicle 102. In box 404, the aggregated telemetry data is used to create an anchor point 202 by determining a confidence value for the anchor point and then comparing the confidence value to a confidence threshold. A detailed explanation of the methods of box 404 is provided herein with respect to FIGS. 5 and 6.

Still referring to FIG. 4, in box 406, crowdsourced vehicle data is received at the map server 104. The crowdsourced vehicle data can include, but is not limited to, detection data obtained at a plurality of vehicles, such as camera image data, lidar data, radar data, raw detection data, or any combination, thereof. The detection data obtained at a lane marking with respect to the vehicle. The relative location of the lane marking is combined with knowledge of the vehicle's location, velocity, heading, etc., to provide a location of the lane marking within a map at the map server 104. The vehicle's location, velocity, heading, etc., can be provided by GPS data. The crowd-sourced data identifies a possible location of a boundary marking and as well as a confidence level for the possible location. In box 408, the confidence levels of the possible locations are used to select an anchor point 202 from the crowdsourced data. The crowdsourced data is useful in determining a location of the lane marking.

In box 410, aerial imagery is received at the map server 104. In box 412, image processing can be used to identify possible anchor points 202 within an aerial image and a confidence level can be associated with the possible anchor points. The boundary marking obtained using the aerial imagery can include an edge marking for the road segment 200.

The anchor points from boxes 404, 408 and 412 are considered candidates for anchor points 202 and are aggregated at the aggregator 414. In box 416, a candidate point is selected from the plurality of candidates to be a representative anchor point for the location of the road segment. The selected anchor point can be the candidate that has an optimal or highest associated confidence level. This process shown in flowchart 400 of determining an anchor point can be repeated for other locations along the road segment 200 to therefore generate anchor points for a plurality of locations along the road segment.

FIG. 5 shows a flowchart 500 of a method of determining anchor points from telemetry data. Telemetry data for a vehicle includes location, velocity, orientation, direction of travel, etc. of the vehicle. In box 502, telemetry data is obtained from a plurality of vehicles traveling along a road section. The telemetry data is represented by telemetry points 512 in image 510. In box 504, the telemetry data is partitioned based on the headings or direction of travel of the vehicles. In general, a vehicle is moving either in one direction along the road, as indicated by first telemetry points 516 in image 514, or in the opposite direction, as indicated by second telemetry points 518 in image 514. In box 506, a separator line 522 is determined (as shown in image 520) that represents the calculated location of the center marking of the road segment.

FIG. 6 shows a region 600 of a road segment illustrating a method for selecting a separator line 522 using a confidence threshold. A separator line 606 is drawn to separate the region 600 into a first subregion 608 and a second subregion 610. The first subregion 608 is designated as including vehicles flowing in the first direction and the second subregion 610 is designated as including vehicles flowing in the second direction. Once the separator line 606 is drawn, the directions of the vehicles are compared to the subregions they inhabit to determine a confidence level for the separator line 606.

When a direction of the vehicle is the same as the subregion for which the direction is designated, a positive count is made. For example, first point 614 represents a vehicle traveling in a first direction. Since first point 614 is in the first subregion, the direction of the vehicle represented by first point 614 is the same as the direction designated for the first subregion 608 and a positive count is made. On the other hand, second point 616 represents a vehicle traveling in the second direction. Since the direction of the vehicle represented by second point 616 differs from the designated direction of the first subregion 608, no positive count is made. Similarly, third point 618 represents a vehicle traveling in a second direction and is in the second subregion 610. Therefore, direction of the vehicle represented by third point 618 is the same as the designated direction for the second subregion 610 and a positive count is made. Fourth point 620, however represents a vehicle traveling in the first direction, but is in the second subregion 610. Since the direction of the vehicle represented by fourth point 620 differs from the designated direction of the second subregion 610, no positive count is made.

Summing the positive counts for the region 600 yields a confidence number. For the region 600, there are 40 points, 36 of which have directions that match their designed subregions. The confidence number for region 70 is therefore 36/40. The confidence number is compared to a confidence threshold (e.g., 0.9) in order to determines whether the separator line is acceptable as designating an anchor point. For the separator line 606, the confidence level is greater than the confidence threshold and is therefore accepted. An anchor point 622 can be selected as any point on the separator line 606.

FIG. 7 illustrates a separator line 702 that is not acceptable using the confidence threshold method discussed with respect to FIG. 6. The separator line 702 separates the region 700 into the first subregion 704 designated for vehicle traveling in a first direction and the second subregion 706 designated for vehicles traveling in a second direction. Hollow point 708 represents a vehicle that is traveling in the first direction and shaded point 710 represents a vehicle traveling in the second direction. Using the methods discussed with respect to FIG. 7, the confidence level for the separator line 702 is 23/40. This confidence level is less than the confidence threshold and therefore the separator line 702 is not accepted.

A discussion of crowd-sourced data is now provided. For the crowdsourced data (box 406), detection data and GPS data are received from a plurality of vehicles. For a given vehicle, a detection of a lane marking and the GPS data are sensed by the vehicle. This detection and GPS data from the plurality of vehicles are aggregated at the map server 104 to locate the boundary. The data are sent from the vehicles with associated confidence levels that indicate a confidence in the location of the boundary. A combined confidence score for the boundary is based on the confidence levels for each point, as shown in Eq. (1):

$${Score}_{Crowdsource} = \{ \begin{matrix}\frac{1}{N} {\sum }_{k = 1}^{N} {c}^{( k )} & if N \geq T \\ 0 & else\end{matrix} \qquad Eq . ( 1 )$$

where N is the number of vehicles, T is a count threshold and c^{(k)} is a confidence level for the k^{th} data point. When the number of vehicles contributing data for crowdsourcing is greater than the count threshold T, the crowdsourced score is an average of the individual confidence levels of the data. When the number of vehicles contributing data for crowdsourcing is less than the count threshold T, the crowdsourced score is assigned the value of zero.

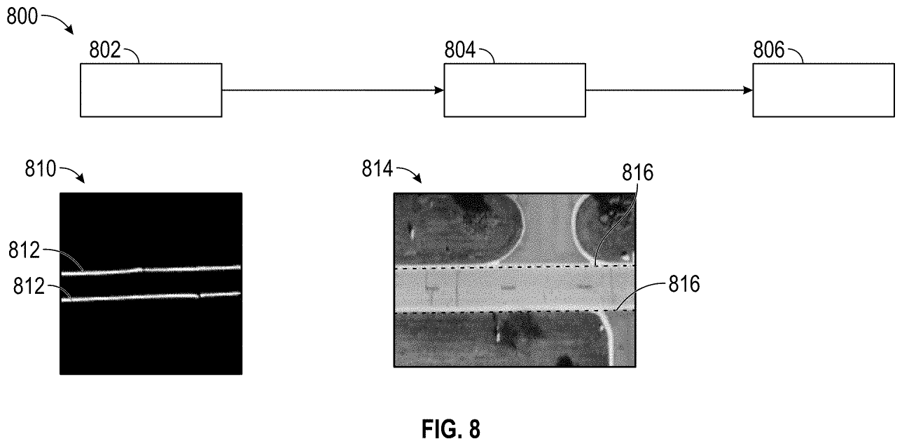

FIG. 8 shows a flowchart 800 of a method for determining a boundary marking from an aerial image. In box 802, a region is defined and a set of probabilities is defined of the region that indicates a probability of a location of a boundary marking. As shown in image 810, lines 812 indicate a higher probability for being a location of a boundary marking, with respect to the area surrounding the lines. In box 804, the probability region is compared to an aerial image 814 of a road segment to identify a boundary marking, such as edge marking 816, to determine a probability count. The probabilities are summed to determine an edge probability P_{edge} for an anchor point selected from the aerial image 814, as shown in Eq. (2);

$${P}_{edge} = \frac{1}{l} {\sum }_{k = 1}^{N} {P}_{k} \qquad Eq . ( 2 )$$

where Pₖ is the probability associated with a road edge point and l is an edge length. In box 806, the sum of probabilities is normalized to obtain a confidence score within a range from 0.0 to 1.0. The normalization allows for a side-by-side comparison of the anchor point obtained from the aerial image and anchor points obtained by the other methods.

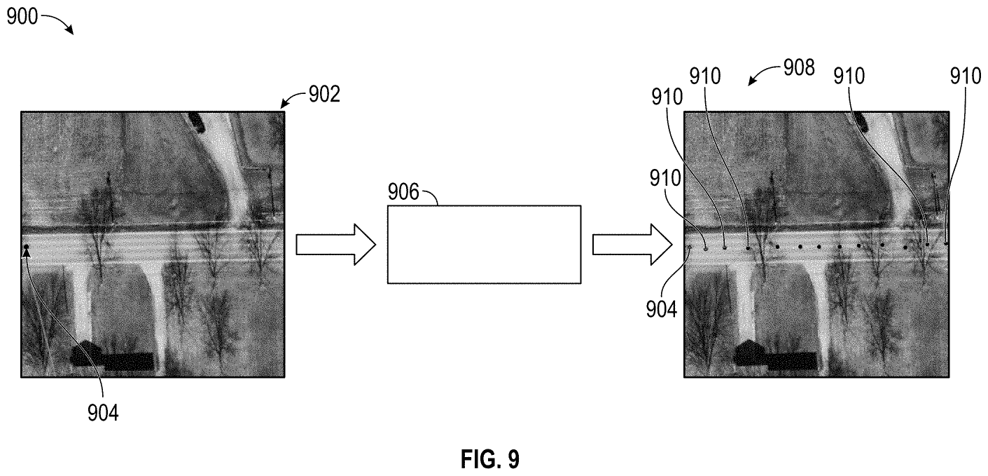

FIG. 9 illustrates a stitching step 900 for predicting a boundary marking. Input image 902 shows a road segment having an anchor point 904 at a selected location. The input image 902 and the anchor point 904 are input to a sequence estimation model 906 to generate an output image 908 that includes the anchor point 904 and a plurality of predicted points 910.

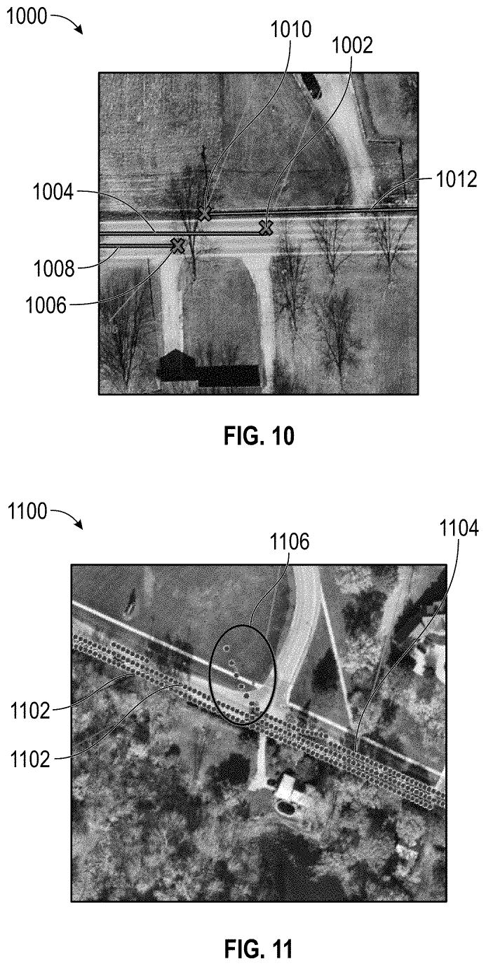

FIG. 10 shows an aerial image 1000 of a road segment showing various boundary markings that can be determined using the methods disclosed herein. Anchor point 1002 can be used to mark a boundary that represents center marking 1004 of the road segment. Anchor point 1006 can be used to mark a boundary that represents a lane marking 1008. Anchor point 1010 can be used to mark a boundary that represents an edge marking 1012.

FIG. 11 shows an image 1100 illustrating a method for correcting a previously generated HD/MD (high definition/low definition) map for road boundaries. The image 1100 is from an HD/MD map that includes boundary markings drawn on the image using an HD/MD mapping process. The boundary markings 1102 are shown to follow their respective boundaries, such as center marking and edge marking. However, the boundary marking 1104 includes a region 1106 in which the HD/MD mapping process has produced a poor boundary. By comparing a boundary marking determined using the methods disclosed herein with the boundaries from the HD/MD map, poor boundaries can be identified, flagged, verified and/or corrected prior to providing the map to the vehicle for navigation. When the boundary marking from the map service is verified for a selected road segment, the map can be provided to the vehicle for navigational purposes. When the boundary marking is not verified, the vehicle can be instructed to navigate using a different method or service.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of generating a map, comprising:
determining an anchor point for a location of a road segment based on data from at least one data source;
placing the anchor point within an aerial image of the road segment;
predicting a boundary marking of the road segment on the aerial image based on the anchor point to form the map; and
providing the map to a vehicle.

2. The method of claim 1, wherein the at least one data source comprises at least one of: (ii) a vehicle telemetry data source; (ii) crowd-sourced data; and (iii) an aerial imagery data source.

3. The method of claim 1, wherein determining the anchor point further comprises determining a plurality of candidates, each candidate having an associated confidence level, and selecting a candidate as the anchor point from the plurality of candidates based on the associated confidence level.

4. The method of claim 1, wherein the boundary marking of the road segment further comprising at least one of: (i) a center marking of the road segment; (ii) a lane marking of the road segment; and (iii) an edge marking of the road segment.

5. The method of claim 1, wherein the boundary marking is missing on a previously generated map from a map service.

6. The method of claim 5, further comprising comparing the predicted boundary marking to a boundary marking in the previously generated map from service to identify an error in the map from the map service.

7. The method of claim 1, further comprising determining the anchor point and the predicted boundary marking of the road segment at a remote processor and providing the predicted boundary marking to a processor of the vehicle to operate the vehicle.

8. The method of claim 1, further comprising navigating the vehicle along the road segment using the boundary marking in the map.

9. A system for generating a map, comprising:
a processor configured to:
determine an anchor point for a location of a road segment based on data from at least one data source;
place the anchor point within an aerial image of the road segment;
predict a boundary marking of the road segment on the aerial image based on the anchor point; and
provide the boundary marking to a vehicle for navigation of the vehicle along the road segment.

10. The system of claim 9, wherein the at least one data source comprises at least one of: (ii) a vehicle telemetry data source; (ii) crowd-sourced data; and (iii) an aerial imagery data source.

11. The system of claim 9, wherein determining the anchor point further comprises determining a plurality of candidates, each candidate having an associated confidence level, and selecting a candidate as the anchor point from the plurality of candidates based on the associated confidence level.

12. The system of claim 9, wherein the boundary marking of the road segment further comprises at least one of: (i) a center marking of the road segment; (ii) a lane marking of the road segment; and (iii) an edge marking of the road segment.

13. The system of claim 9, wherein the processor is further configured to predict the boundary marking that is missing from a previously generated map from a map service.

14. The system of claim 13, wherein the processor is further configured to compare the predicted boundary marking to a boundary marking in the previously generated map to identify an error in the map from the map service.

15. The system of claim 9, wherein the processor is a remote processor to a vehicle and the processor provides the predicted boundary marking to a vehicle processor that uses the predicted boundary marking to operate the vehicle.

16. A system for navigating a vehicle, comprising:
a remote processor configured to:
determine an anchor point for a location of a road segment based on data from at least one data source;
place the anchor point within an aerial image of the road segment;
predict a boundary marking of the road segment on the aerial image based on the anchor point; and
provide the boundary marking to the vehicle; and
a vehicle processor for navigating of the vehicle along the road segment using the boundary marking.

17. The system of claim 16, wherein the at least one data source comprises at least one of (ii) a vehicle telemetry data source; (ii) crowd-sourced data; and (iii) an aerial imagery data source.

18. The system of claim 16, wherein determining the anchor point further comprises determining a plurality of candidates, each candidate having an associated confidence level, and selecting a candidate as the anchor point from the plurality of candidates based on the associated confidence level.

19. The system of claim 16, wherein the boundary marking of the road segment further comprising at least one of: (i) a center marking of the road segment; (ii) a lane marking of the road segment; and (iii) an edge marking of the road segment.

20. The system of claim 16, wherein the remote processor is further configured to predict the boundary marking that is missing from a previously generated map using the anchor point.
